(19) United States
(12) Patent Application Publication
(10) Pub. No.: US 2010/0114909 A1
(43) Pub. Date: May 6, 2010

(54) SYSTEM AND METHOD FOR IMPROVED GRID PROCESSING

(75) Inventor: Ken Museth, Marina Del Rey, CA (US)

Correspondence Address: PERKINS COIE LLP, P.O. BOX 1208, SEATTLE, WA, 98111-1208, US

(73) Assignee: Digital Domain Productions, Inc.

(21) Appl. No.: 12/265,683

(22) Filed: Nov. 5, 2008

(51) Int. Cl. G06F 7/00; G06F 17/30

(52) U.S. Cl. 707/748; 707/E17.051

(57) ABSTRACT

A method and system for improved processing of volumetric data. The method includes encoding the volumetric data into a plurality of blocks, wherein each block is associated with: a block topology denoting a relative location of the block within the volumetric data and a set of elements, and each element is associated with: an element topology denoting a relative location of the element within the associated block and a data value. The method includes encoding each block into a value table and an element bit-mask, wherein the value table stores element values, and the element bit-mask indicates non-zero element values. The method includes randomly accessing an element value, further comprising: determining a selected block containing the element value from the element coordinate, computing a value table offset from the element coordinate, and accessing the element value in the value table with the value table offset.

### BACKGROUND OF THE INVENTION

Volumetric data are used in various fields such as applied mathematics, physics, engineering, computer graphics, and scientific visualization. Example applications include propagation of level sets, fluid simulations, study of material structures, implicit geometry and volume rendering. One common type of volumetric data employs uniform 3D grids, i.e. isotropic and axis-aligned grids. A majority of 3D grids do not store sample values at every single grid point. Instead, 3D grids only store sample values at a grid point if the sample value is non-zero or otherwise needed.

Such sparse volumetric data sets pose a special challenge because the topology (i.e. layout or connectivity) of the actual data can be arbitrarily complex. Ideally, a memory footprint of the sparse volume should scale with the number of grid points that actually contain sample-values, as opposed to the volume of the embedding-space (i.e. axis-aligned bounding box).

Hierarchical uniform 3D grids have been employed in computer graphics and related fields for many years. One data structure of this type is the uniform octree, a tree data structure where each internal node has up to eight children. Each child represents one of the eight octants associated with an internal node. This partitions a three dimensional space by recursively subdividing into eight octants. Each leaf node corresponding to a grid point is at the same level of the tree.

While uniform octrees offer some advantages for static data, the cost of re-building and navigating the tree can be high. Furthermore, most implementations suffer from slow (i.e. logarithmic complexity) random access and significant memory overhead.

Blocked uniform 3D grids typically partition a dense uniform 3D grid into tiles or sub-grids to improve data-locality and cache efficiency. However, such blocking techniques are not optimized for sparse data because they pre-allocate all blocks corresponding to a regular dense 3D grid.

The level set method, originating from interface studies in applied mathematics, provides a mathematical toolbox that allows for direct control of surface properties and deformations. Although not required by the level set method, surfaces are typically represented implicitly by their sampled signed distance field, Φ, and deformations are imposed by solving a time-dependent partial differential equation (PDE) by means of finite difference (FD) schemes.

To obtain a computational complexity which scales with the area of the surface, as opposed to the volume of its embedding, several narrow band schemes have been proposed. These schemes exploit the fact that the zero level set of f uniquely defines the surface and hence the PDE only needs to be solved in a narrow band around Φ=0. While these methods decrease the computational complexity, memory requirements still scales with the volume of the embedding. In recent years a number of improved data structures have addressed this issue and dramatically reduced the memory footprints of level sets, thereby allowing for the representation of geometry at higher resolutions. This includes the use of tree structures, blocked grids, blocked grids on the GPU, dynamic tubular grids (DT-Grid) as well as run-length encoding applied along a single dimension and hierarchically (H-RLE). However none of these data structures can encode data with random topology, since they were developed specifically for level sets, and do not support fast random access operations.

Thus, there is a need for a fast and compact data structures for general sparse 3D grids that is easy to implement and adapt to existing applications.

### BRIEF DESCRIPTION OF THE DRAWINGS

The features and objects of the present disclosure will become more apparent with reference to the following description taken in conjunction with the accompanying drawings wherein like reference numerals denote like elements and in which:

FIG. 1 illustrates an example two-dimensional surface in a blocked space.

FIG. 2A illustrates a first example block for a portion of the two-dimensional model.

FIG. 2B illustrates a second example block for a portion of the two-dimensional model.

FIG. 3A illustrates a first example encoded block for a portion of the two-dimensional model.

FIG. 3B illustrates a second example encoded block for a portion of the two-dimensional model.

FIG. 4 illustrates an example data hierarchy for a 3D grid.

FIG. 5 illustrates a procedure for improved processing of volumetric data.

FIG. 6 illustrates an example workstation for improved processing of volumetric data.

FIG. 7 illustrates an example server for improved processing of volumetric data.

### DETAILED DESCRIPTION

Volumetric data, such as a surface in a 3D grid, can be represented as grid points, each grid point associated with a value. The volumetric data is divided into blocks, which are further subdivided into elements. Because it is likely that only a small portion of the grid points will have non-zero values, only blocks containing non-zero elements need be stored in memory (“dirty” blocks). This data structure allows for fast random access of elements with a memory footprint that scales with the size of the surface.

The present invention has numerous advantages over prior approaches, including:

General topology: effectively store and manipulate sparse uniform data of arbitrary topology.

Fast data access and algorithms: constant random and sequential data access. This allows implementation of fast algorithms that use sequential stencil-access and even random access. Additionally the overall blocking approach permits fast per-block operations as oppose to slower per-element operations.

Simplicity: ease of design and implement compared to prior approaches.

Flexibility: random and constant time push and pop of elements analogously to regular dense 3D grids. Thus, most algorithms and numerical schemes can easily utilize the present invention.

Low memory footprint: the present invention is generally very compact and some configurations use less memory than prior approaches that have been optimized for specific applications.

High resolutions: by reducing memory and computation requirements, the present invention allows for very high effective grid resolutions (in some configurations even virtually unlimited grid resolutions).

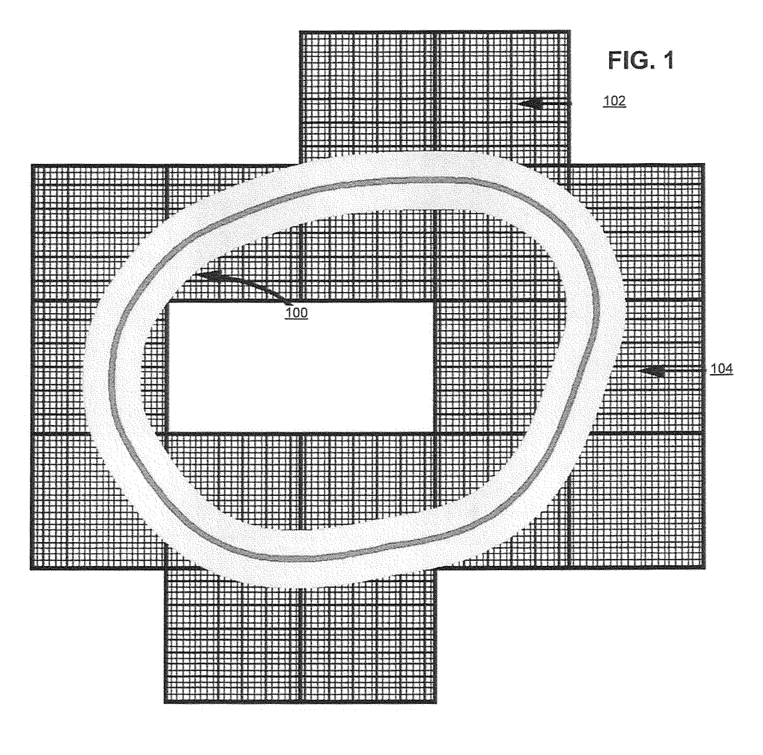

FIG. 1 illustrates an example two-dimensional surface 100 in a blocked space. The universe can be represented as a set of blocks. The surface 100 is traced along blocks, each block divided into elements. Example blocks 102 and 104 will be discussed later.

It will be appreciated that while only a two-dimensional surface is illustrated, the procedures and systems discussed herein can easily be applied to three- or more dimensional surfaces.

In general, grids encode two distinct types of information: data values stored at each grid-point and the topology or location of the grid-points. For example, if P (7, 16, 25)=5.6, the value is V=5.6 and the topology is (x, y, z)=(7, 16, 25).

In the present invention, the data value and the topology are distributed across two levels of the data structure: blocks and elements. Blocks can be axis-aligned partitions of the grid into sets of topologically connected elements. Each element represents a single grid-point. Blocks can be cubic and uniform. Thus, all blocks can be characterized by a single fixed parameter, B_{dim}, denoting the axis-aligned dimension. Efficient implements can utilize a binary number, for example, B_{dim}=1, 2, 4, 8, 16, 32 . . . corresponding to B_{log 2}=0, 1, 2, 3, 4, 5 . . . . This allows the block and element topology to be determined by the following very fast bit operations

$$\begin{matrix}( \begin{matrix}I \\ J \\ K\end{matrix} ) = ( \begin{matrix}x >> {B}_{log 2} \\ y >> {B}_{log 2} \\ z >> {B}_{log 2}\end{matrix} ) & ( 1 ) \\ ( \begin{matrix}i \\ j \\ k\end{matrix} ) = ( \begin{matrix}x \& ( ( 1 << {B}_{log 2} ) - 1 ) \\ y \& ( ( 1 << {B}_{log 2} ) - 1 ) \\ z \& ( ( 1 << {B}_{log 2} ) - 1 )\end{matrix} ) & ( 2 )\end{matrix}$$

where “>>” and “<<” denote the “right-shift” and “left-shift” bit operators respectively, and “&” is the logical “AND” bit-operator. Also note the simple relation B_{dim}=1<<B_{log} 2, which effectively implies B_{log} 2as a global (template) parameter for the present invention.

In an example, B_{log} 2=3, i.e. B_{dim}=8. Then P(7, 16, 25)=5.6 is encoded as B(0, 1, 3)→E(7, 0, 1)=5.6 where (I, J, K)=(0, 1, 3) is the block topology, (i, j, k)=(7, 0, 1) is the element topology and V=5.6 is the value.

Sparse grids typically have a large degree of spatial coherency in both the topology and the values. Thus, memory usage can be minimized because the above structure encodes the two types of information in a spatially coherent (block) data structure. For example, topologically connected clean grid-points (e.g. constant or undefined values) can compactly be represented by empty blocks. For example, all blocks in the universe of FIG. 1 except for those depicted are clean blocks. In contrast, regions with topologically connected dirty grid-points can be represented by encoded blocks, discussed below.

Thus, the data structure includes three conceptual levels: the grid, blocks and elements. In one example, the structure can be implemented with two levels: a grid-block (i.e. inter-block) data structure and block-element (i.e. intra-block) data structures.

Grid-Block Data Structure

This data structure maintains pointers to blocks whose union completely contains the grid. The grid-block data structure exists at the top-level of the grid and does not contain the actual values of the grid points, but rather points to the “containers for the elements”, i.e. blocks. More specifically, the grid-block data structure encodes pairs of the following information: the block topology and a corresponding pointer to the intra-block data structure, discussed later. The grid-block data structure can be implemented as a linear block-table (LBT) or a hashed block-table (HBT).

Linear Block-Table (LBT)

In one example embodiment, the grid-block data structure can be a linear lookup table large enough to hold all the block pointers of the grid. The corresponding block topology of an element can conveniently be represented by a linear offset

m=I*Dim_{J}*Dim_{K}+J*Dim_{K}+K (3)

which simply maps the block topology (I, J, K) to the m'th entry in the block table. Because the block table is typically only partially full (i.e. contains multiple pointer to empty blocks), it is helpful to quickly search for dirty blocks. This is effectively accomplished by an additional block bit-mask (i.e. 1 for dirty blocks and 0 for empty blocks).

It will be appreciated that it is much more efficient to perform search operations into the block bit-mask than directly into the linear block table. The block bit-mask is much more compact (hence cache efficient) than the block-table. Further, entries in the block bit-mask can be pruned in parallel (e.g. 32 entries at a time with “unsigned int” bit-operations).

The LBT approach allows for optimal (constant time) sequential and random access of blocks, at a cost of memory overhead associated with the empty block pointers in the block table. In practice this turns out to be a minor overhead for reasonably sized grids and blocks. For example, if the effective resolution of the grid is 1024³ and B_{dim}=16, then the full block table is only 64³ or approximately 8 Mb. For offline storage or pure sequential block access it is also very easy and fast to compress the block table (i.e. remove the empty block pointers) with of the bit-mask. A count of “1” entries in the bit-mask is obtained and used to generate a smaller linear block-table that only contains pointers to dirty blocks. To decompress the block-table, the bit-mask is used to expand the block-table with empty block pointers.

Thus, the bit-mask allows for fast search within the block and compression/decompression of the block table.

Hashed Block-Table (HBT)

In an alternative embodiment, the block topology and pointers can be encoded into a hash-table. This allows for virtually unlimited grid resolutions by not limiting the block pointers to a linear table. In practice, this approach has close to constant time random access (sequential access is of course still constant). However, the HBT approach is generally slower than the LBT approach which is a simple consequence of the fact that the latter can be viewed as a “trivial hash-table” with no collisions. On the other hand HBT is generally more compact since it does not necessarily store empty block pointers, i.e. the memory footprint scales linearly with the number of dirty blocks. In addition, HBT has no fixed underlying domain (i.e. bounding box) of the grid. Blocks can be added to the HBT regardless of their topology, whereas the LBT might have to be resized if the block topology falls outside of the initial grid domain. However, it should be emphasized that due to the small size of the LBT a resize operations is typically very fast.

Some embodiments, such as those employing closed implicit surfaces (e.g. level sets), can require additional information for empty blocks. For these applications, it is important to also know if an empty block is inside or outside of the implicit surface (e.g. for signed distance fields). For LBT, this is trivial since the empty pointer in the block table can simply point to either an outside-block or an inside-block. For HBT, the simplest approach is to also store points to empty inside blocks, which of course also implicitly defines empty outside blocks.

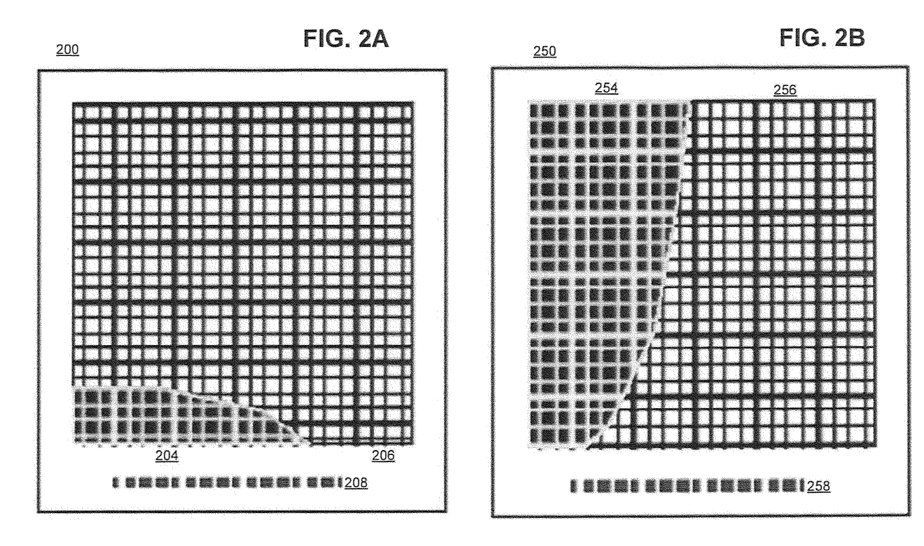

FIG. 2A illustrates a first example block 200 for a portion of the two-dimensional model. The block 200 can correspond to block 102 of FIG. 1. Block 200 includes dirty elements 204, which contain values, and clean elements 206, which are empty. An element bit-mask 208 can be used as discussed below to compress/decompress and process block 200.

Similarly, FIG. 2B illustrates a second example block 250 for a portion of the two-dimensional model. The block 250 can correspond to block 104 of FIG. 1. Block 250 includes dirty elements 254, which contain values, and clean elements 256, which are empty. An element bit-mask 258 can be used as discussed below to compress/decompress and process block 250.

Each block is represented by a block→element data structure. This (intra-block) data structure allows for storage of and access to the actual values of elements inside dirty blocks. Specifically it encodes the element values and their topology. Since the blocks have a fixed size, a similar approach to LBT can be utilized. Thus, the values of the elements are stored in a linear array, denoted the value table, and the corresponding topology (i.e. linear offsets into the value table) is encoded very efficiently as bits in an element-mask, i.e. 1 for dirty elements and 0 for clean elements.

As in the case of LBT, the dirty elements can be compressed inside a block using the element-mask. This is illustrated for two different blocks in FIG. 2. The element-mask can then (optionally) be further compressed by run-length-encoding on the bits. Likewise any lossless codec can be applied to compress the value table to reduce the memory footprint of the block even more.

It will be appreciated that it is generally not a good idea to apply hash tables for the dirty elements. Unlike for HBT, with typically a few thousand dirty blocks, high-resolution images can easily contain several million or even billions of elements. This leads to slow element lookups (due to hash-key collisions) which in turn impacts random access as well as finite-difference computations that use element stencils, discussed below. In contrast, access into the element-mask and value-table as discussed above is very fast.

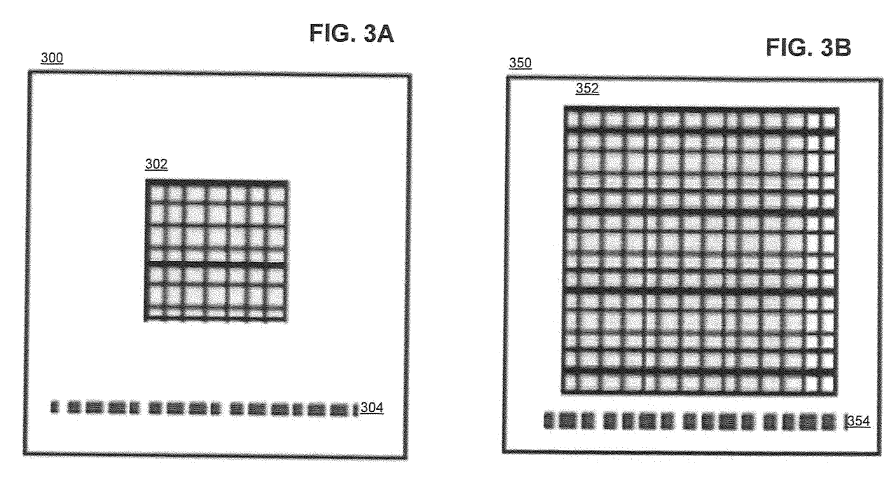

FIG. 3A illustrates a first example encoded block 300 for a portion of the two-dimensional model. As discussed above, block 200 of FIG. 2A can be compressed into a compressed value table 302 by using the element bit-mask 304. The element bit-mask 304 can be the element bit-mask 208 of FIG. 2A.

Similarly, FIG. 3B illustrates a second example encoded block 350 for a portion of the two-dimensional model. Block 352 is a compressed value table of block 250 illustrated in FIG. 2B. An element bit-mask 354 is used for the compression/decompression processes. The element bit-mask 354 can be the element bit-mask 258 of FIG. 2B.

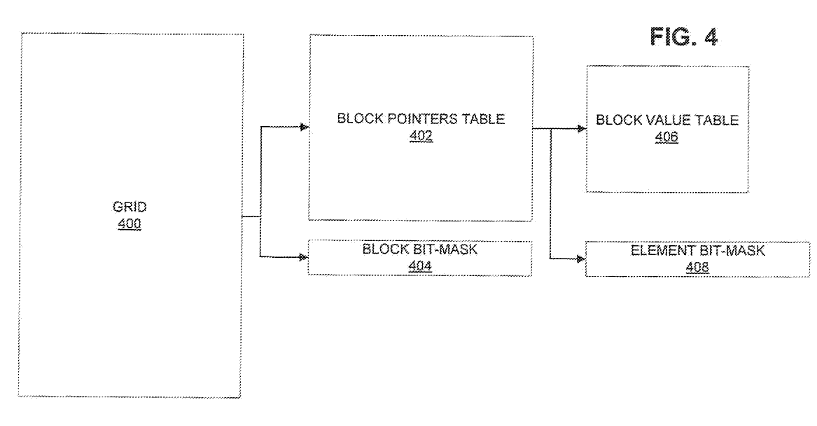

FIG. 4 illustrates an example data hierarchy for a 3D grid. A grid 400, as discussed above, is represented by a block pointers table 402 and a block bit-mask 404. The block pointers table 402 can be the grid→block data structure discussed above. The block bit-mask 404 can be an associated bit-mask used in an LBT implementation to improve performance. The block pointers table 402 can be implemented with an LBT or HBT approach, as discussed above.

The block pointers table 402 can point to one or more block value tables 406. Each value table 406 can be associated with an element bit-mask 408, used for processing and compressing the block value table 406. For example, the block value table 406 can be encoded or compressed, as discussed above.

The simplicity of the above methods and systems provides many advantages. Fast random data access allows the method and systems to be applied to problems with complex data access patterns, such as stencil access for finite differences. Essentially, random access can be views as the most fundamental access operation, from which all other access-patterns can be derived.

The present invention supports constant-time (i.e. optimal) random access operations like push (add a value), pop (remove a value), read (retrieve a value) and write (set an existing value). In comparison most current state-of-the-art sparse grid data structures, like DT-Grid [Nielsen and Museth 2006] and HRLE [Houston et al. 2006], do not support random push or pop and only supports logarithmic-time (i.e. sub-optimal) random read and write operations.

Random data access in the present invention requires navigating the two-level data structure discussed above. Given P(x, y, z)=V, the (x, y, z) is decomposed into (I, J, K) and (i, j, k). This uniquely identifies the block/element pair B (I, J, K)→E (i, j, k)=V. This in turn allows trivially for random read and write of element values.

If, however, B(I, J, K) does not already exit in the grid→block data structure, a new block is created by allocating a new block, pushing it into the grid→block data structure, and pushing E(i, j, k)=V into a corresponding element value table.

Similarly, a pop operation is performed in reverse order. First, pop E (i, j, k). Then the grid→block data structure can delete B (I, J, K) if it is empty. The explicit performance of these push/pop operations naturally depend on implementations of respectively the grid→block and block→element data structures. For example, with the LBT approach discussed above, the push/pop updates both the pointer table and the associated bit-mask, which can be performed in constant time. With the HBT approach, the push/pop operations for B(I, J, K) are executed using a hash function on (I, J, K) which is typically also a constant time operation (assuming no collision by the hash function).

The element access is always constant in time if the (dirty) block is decompressed, i.e. the size of the value table is exactly B_{size}. If the blocks are encoded, i.e. the value table is smaller then B_{size} and compressed, random push/pop will not be performed in constant time.

The trivial solution is to ensure a block is decompressed before i.e. there is a one-to-one mapping between the value-table and the element bit-mask. In practice, it is uncommon to encode/decode the blocks during computations, though it is actually surprisingly fast (e.g. less than a tenth of a second for a complete structure at effective resolution of 1024³). The memory overhead of keeping (dirty) blocks decoded is usually small for reasonably sized grids and blocks.

However, the blocks should be encoded for off-line storage (on hard disks). For such operations, 10 bandwidth is the bottleneck. One possibility for online compression is to use a multi-threaded paging scheme that pre-fetches encoded blocks, decodes them before accessed, and evicts (i.e. encodes) old blocks when the block-page table is full. The efficiency of such a paging scheme of course depends on the success of the pre-fetching, which in turn is related to the predictability of the data access pattern. For sequential access, discussed below, this scheme will be highly effective. However, the scheme will likely be less effective for random access.

Fast Sequential Data Access

In practice, it is uncommon to require true random access in a uniform grid. In fact, many applications that employ uniform grids simply need to pass through (i.e. access) all the grid points (and possibly its local neighborhood) in an arbitrary order. In other words, these algorithms are independent of the specific sequence by which the grid points are visited. Examples hereof are most applications that solve partial differential equations on a uniform grid (e.g. level set and fluid equations). This is an important property of many grid applications since all data structures have a preferred sequence of data access, namely the order in which the data is physically stored (or laid out) in memory. With modern CPUs and complex memory hierarchies (e.g. data pre-fetching into cache levels), it is increasingly important to fetch and process data in the order they are stored in main memory.

Additionally, many data structures have a significantly lower computational overhead associated with memory sequential access than with other access patterns. Important exceptions to this rule are dense grids and to a large extend the present invention. The present invention stores elements in lexicographic order of the element topology, (i, j, k), and therefore offers constant-time read and write to elements for this type of sequential order only. As discussed above, the present invention offers constant time random access, but memory sequential access is even faster due to lower computational overhead and better cache coherency. The remaining question is of course how such a sequential access is implemented efficiently.

Elements in the present invention are stored in lexicographic order of the element-topology (i, j, k). The storage order of blocks depends on the order in which they are added to the grid, i.e. allocated and pushed into the grid→block data structure, discussed above. For LBT, the block-pointers are stored in lexicographic order in the block topology, (I, J, K). For HBT, storage order depends on the hash-function applied to (I, J, K). To facilitate efficient (memory) sequential data access, three iterators are offered; block-, element- and grid-iterators.

Block- and element-iterators visits respectively blocks and elements in their local storage order, while grid-iterators combine both in a convenient iterator of all grid points. Element-iterators are very efficiently implemented by searching the element bit-mask for non-zero entries. This is fast since multiple byte sections of the bit-mask can be pruned for zero entries by means of regular expressions with data-types like unsigned char (8 bit) or int (32 bit). Furthermore, the bit-map is very compact which improves cache-efficiency. The same approach is used for the block-iterator when employing LBT, whereas the HBT simply uses hash-table iterators.

Various versions of each iterator are possible. Dirty iterators only visit dirty (i.e. defined) blocks, elements or grid-points. Dense and empty iterators visits respectively all or empty blocks, elements or grid-points in a given grid domain (e.g. derived from the LBT). Finally, for applications involving closed implicit surfaces, it is useful to define inside and outside iterators that sequentially visits blocks, elements or grid-points that are respectively inside or outside of the surface.

Fast Stencil Data Access

Stencil access on uniform grids is a fundamental requirement for all so-call finite difference (FD) schemes. These schemes discretize partial differential equations by approximate expressions involving grid-points in a local neighborhood called the support-stencil.

These stencils can vary wildly depending of the accuracy and type of the FD scheme. For example the 3'rd-5'th order accurate WENO FD scheme uses 18 neighboring grid-points whereas 1'st order single side FD only uses 6 neighboring grid points. In any case, it is important that the present invention allows for fast access to stencils of elements rather than merely a single element. Additionally these stencil access methods are typically combined with fast sequential access since most FD algorithms do not require random access.

One approach achieves constant time sequential stencil access by grouping regular sequential iterators, one for each grid-point in the support-stencil. This comes at a cost of inherent computational overhead of having to update as many iterators as there are entries in the stencil. In the present invention, the sequential iterators can be combined and use the fast random access for all the neighboring access defined by the stencil. This effectively gives constant time sequential stencil access and has the additional advantages of being easy to implement. As a further optimization, if all the stencil-elements lie inside the block, the present invention can reuse the block topology, (I, J, K), for all stencil elements which further reduces the computational overhead.

Some grid applications require random stencil access. For example, gradient computations during ray-tracing or volume rendering require such access. This is also supported by the present invention in constant time.

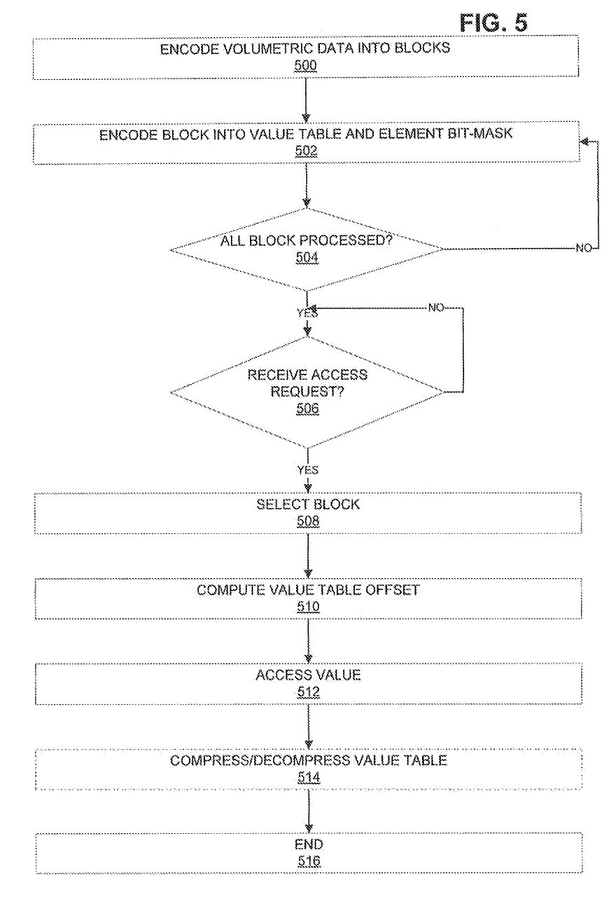

FIG. 5 illustrates a procedure for improved processing of volumetric data. The procedure can be executed by a procedure for processing volumetric data. The procedure can be part of an application executing on a workstation, a server, or a combination of workstation and server as illustrated below.

In 500, the procedure can encode volumetric data into blocks. For example, the volumetric data can represent a three-dimensional grid, as discussed above. By dividing the volumetric data into blocks, empty blocks can be easily represented in a compressed form to reduce memory footprint, as discussed. For example, blocks can be as illustrated in FIGS. 2A and 2B.

In 502, the procedure can encode a block into an element value table and an element bit-mask. For example, a dirty block with non-zero element values can be encoded into an element value table and an element bit-mask as illustrated in FIGS. 3A and 3B.

In 504, the procedure can test whether all blocks of the grid have been processed. If not, the procedure returns to 502. If all blocks have been processed, the procedure proceeds to 506.

In 506, the procedure can test whether an access request has been received. For example, the request can come from an application requiring access to the volumetric data. The request can include element coordinates of an element to be retrieved. If yes, the procedure proceeds to 510. If no, the procedure remains at 506.

In 508, the procedure can select a block based on the element coordinates. As discussed above, the block is easily selected with simple bit operations on the element coordinates.

In 510, the procedure can compute an element value table offset from the element coordinates. As discussed above, the element value table offset is easily computed with simple bit operations on the element coordinates.

In 512, the procedure can access the element's value. For example, the request can be to read the value or update the value. Similarly, the element bit-mask will be updated if necessary.

In 514, the procedure can optionally compress or decompress the value table. It will be appreciated that compression/decompression operations can occur at any point of the procedure, but is likely most valuable when memory footprint must be minimized. For example, the element value tables can be compressed before saving to disk or otherwise transmitted over a fixed-bandwidth medium.

In 516, the procedure can end.

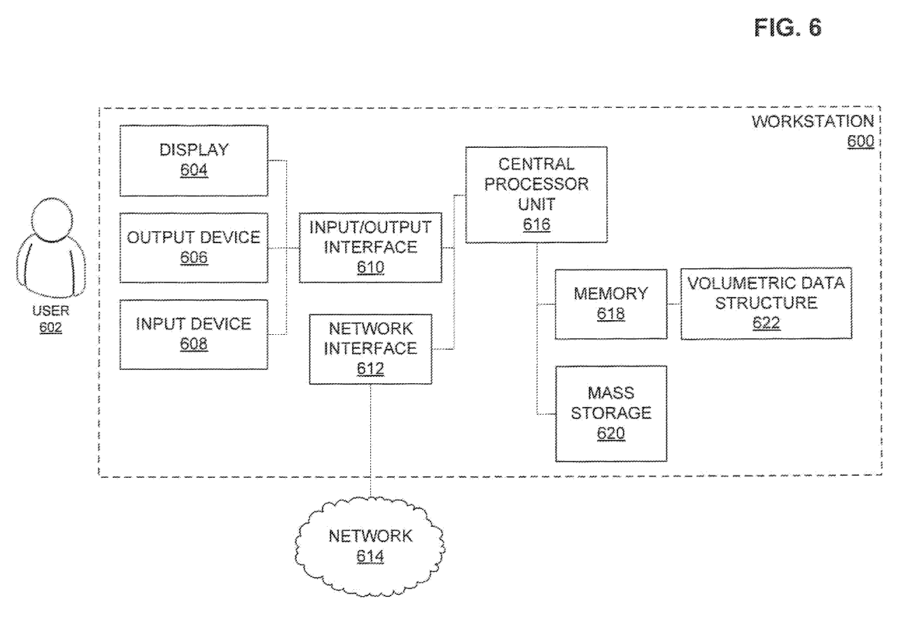

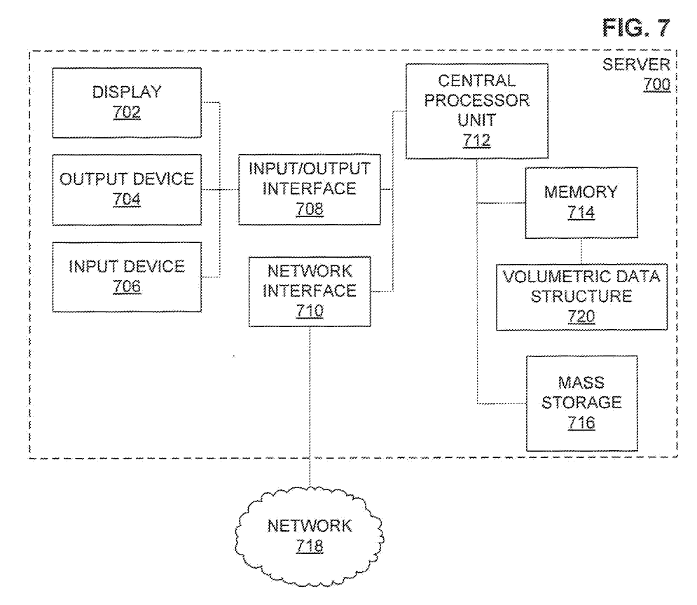

FIG. 6 illustrates an example workstation 600 for improved processing of volumetric data. The workstation 600 can be configured to execute an application requiring processing of volumetric data, as discussed above. In one embodiment, the workstation 600 can be configured to communicate with a server as illustrated in FIG. 7.

The workstation 600 can be a computing device such as a personal computer, desktop computer, laptop, a personal digital assistant (PDA), a cellular phone, or other computing device. The workstation 600 is accessible to the user 602 and provides a computing platform for various applications.

The workstation 600 can include a display 604. The display 604 can be physical equipment that displays viewable images and text generated by the workstation 600. For example, the display 604 can be a cathode ray tube or a flat panel display such as a TFT LCD. The display 604 includes a display surface, circuitry to generate a picture from electronic signals sent by the workstation 600, and an enclosure or case. The display 604 can interface with an input/output interface 260, which forwards data from the workstation 600 to the display 604.

The workstation 600 can include one or more output devices 606. The output device 606 can be hardware used to communicate outputs to the user. For example, the output device 606 can include speakers and printers, in addition to the display 604 discussed above.

The workstation 600 can include one or more input devices 608. The input device 608 can be any computer hardware used to translate inputs received from the user 602 into data usable by the workstation 600. The input device 608 can be keyboards, mouse pointer devices, microphones, scanners, video and digital cameras, etc.

The workstation 600 includes an input/output interface 610. The input/output interface 610 can include logic and physical ports used to connect and control peripheral devices, such as output devices 606 and input devices 608. For example, the input/output interface 610 can allow input and output devices 606 and 608 to be connected to the workstation 600.

The workstation 600 includes a network interface 612. The network interface 612 includes logic and physical ports used to connect to one or more networks. For example, the network interface 612 can accept a physical network connection and interface between the network and the workstation by translating communications between the two. Example networks can include Ethernet, the Internet, or other physical network infrastructure. Alternatively, the network interface 612 can be configured to interface with a wireless network. Alternatively, the workstation 600 can include multiple network interfaces for interfacing with multiple networks.

The workstation 600 communicates with a network 614 via the network interface 622. The network 614 can be any network configured to carry digital information. For example, the network 614 can be an Ethernet network, the Internet, a wireless network, a cellular network, or any Local Area Network or Wide Area Network.

The workstation 600 includes a central processing unit (CPU) 616. The CPU 616 can be an integrated circuit configured for mass-production and suited for a variety of computing applications. The CPU 616 can be installed on a motherboard within the workstation 600 and control other workstation components. The CPU 616 can communicate with the other workstation components via a bus, a physical interchange, or other communication channel.

The workstation 600 includes a memory 618. The memory 618 can include volatile and non-volatile memory accessible to the CPU 616. The memory 618 can be random access and store data required by the CPU 616 to execute installed applications. In an alternative embodiment, the CPU 616 can include on-board cache memory for faster performance.

The workstation 600 includes mass storage 620. The mass storage 620 can be volatile or non-volatile storage configured to store data. The mass storage 620 can be accessible to the CPU 616 via a bus, a physical interchange, or other communication channel. For example, the mass storage 620 can be a hard drive, a RAID array, flash memory, CD-ROMs, DVDs, HD-DVD or Blu-Ray mediums.

The workstation 600 can store a volumetric data structure 622 for a 3D grid, as discussed above. In the example of FIG. 6, in operation, the workstation 600 can execute an application that initiates and utilizes the volumetric data structure 622 for improved volumetric data process, as discussed above.

FIG. 7 illustrates an example server 700 for improved processing of volumetric data. The server 700 can be configured to execute a volumetric data application utilizing the processes and structures discussed above.

The server 700 includes a display 702. The display 702 can be equipment that displays viewable images, graphics, and text generated by the server 700 to a system administrator or user. For example, the display 702 can be a cathode ray tube or a flat panel display such as a TFT LCD. The display 702 includes a display surface, circuitry to generate a viewable picture from electronic signals sent by the server 700, and an enclosure or case. The display 702 can interface with an input/output interface 708, which converts data from a central processor unit 372 to a format compatible with the display 702.

The server 700 includes one or more output devices 704. The output device 704 can be any hardware used to communicate outputs to the user. For example, the output device 704 can be audio speakers and printers or other devices for providing output to the system administrator.

The server 700 includes one or more input devices 706. The input device 706 can be any computer hardware used to receive inputs from the user. The input device 706 can include keyboards, mouse pointer devices, microphones, scanners, video and digital cameras, etc.

The server 700 includes an input/output interface 708. The input/output interface 708 can include logic and physical ports used to connect and control peripheral devices, such as output devices 704 and input devices 706. For example, the input/output interface 708 can allow input and output devices 704 and 706 to communicate with the server 700.

The server 700 includes a network interface 710. The network interface 710 includes logic and physical ports used to connect to one or more networks. For example, the network interface 710 can accept a physical network connection and interface between the network and the workstation by translating communications between the two. Example networks can include Ethernet, the Internet, or other physical network infrastructure.

Alternatively, the network interface 710 can be configured to interface with a wireless network. Example wireless networks can include Wi-Fi, Bluetooth, cellular, or other wireless networks. It will be appreciated that the server 700 can communicate over any combination of wired, wireless, or other networks.

The server 700 includes a central processing unit (CPU) 712. The CPU 712 can be an integrated circuit configured for mass-production and suited for a variety of computing applications. The CPU 712 can be mounted in a special-design socket on a motherboard within the server 700. The CPU 712 can execute instructions to control other workstation components. The CPU 712 can communicate with the other workstation components via a bus, a physical interchange, or other communication channel.

The server 700 includes a memory 714. The memory 714 can include volatile and non-volatile memory accessible to the CPU 712. The memory can be random access and provide fast access for graphics-related or other calculations. In an alternative, the CPU 712 can include on-board cache memory for faster performance.

The server 700 includes a mass storage 716. The mass storage 716 can be volatile or non-volatile storage configured to store large amounts of data. The mass storage 716 can be accessible to the CPU 712 via a bus, a physical interchange, or other communication channel. For example, the mass storage 716 can be a hard drive, a RAID array, flash memory, CD-ROMs, DVDs, HD-DVD or Blu-Ray mediums.

The server 700 communicates with a network 718 via the network interface 710. The network 710 can be as discussed above. The network 718 can be any network configured to carry digital information. For example, the network interface 710 can communicate over an Ethernet network, the Internet, a wireless network, a cellular data network, or any Local Area Network or Wide Area Network.

The server 700 can store a volumetric data structure 720 for a 3D grid, as discussed above. In the example of FIG. 7, in operation, the server 700 can execute an application that initiates and utilizes the volumetric data structure 720 for improved volumetric data process, as discussed above.

In one embodiment, the volumetric data processing can be divided between the server 700 and a workstation as illustrated in FIG. 6. In this case, the volumetric data structure 716 can be stored at the server 700, at the workstation, or divided between the two. For example, it can be beneficial to execute processing at the CPU 712 of the server 700, which can be more powerful.

As discussed above, one embodiment of the present invention can be a method for improved processing of volumetric data. The method includes encoding the volumetric data into a plurality of blocks, wherein each block is associated with: a block topology denoting a relative location of the block within the volumetric data and a set of elements, and each element is associated with: an element topology denoting a relative location of the element within the associated block and a data value. The method includes encoding each block into a value table and an element bit-mask, wherein the value table stores element values, and the element bit-mask indicates non-zero element values. The method includes randomly accessing an element value, further comprising: determining a selected block containing the element value from the element coordinate, computing a value table offset from the element coordinate, and accessing the element value in the value table with the value table offset. The method includes compressing the value table by removing zero element values. The method includes decompressing the value table by adding zero element values as indicated by the element bit-mask. The random access can be an operation selected from: push, pop, read, and write. The selected operation can be required to perform at least one of: a level set deformation and a volume-rendering. Block pointers can be stored in at least one of: a linear block table of pointers and a hash table of pointers. The method includes maintaining a block bit-mask and a linear block table of pointers to the plurality of blocks, wherein the blocks are sized for cache-efficiency. The method includes compressing the linear block table by removing empty blocks. The element bit-mask and the block bit-mask can be used by sequential iterators traversing the volumetric data.

Another embodiment of the present invention can be a system for improved processing of volumetric data. The system includes a memory for storing the volumetric data as a plurality of blocks and elements. The system includes a processor in communications with the memory. The processor is configured to encode the volumetric data into a plurality of blocks, wherein each block is associated with: a block topology denoting a relative location of the block within the volumetric data and a set of elements, and each element is associated with: an element topology denoting a relative location of the element within the associated block and a data value. The processor is configured to encode each block into a value table and an element bit-mask, wherein the value table stores element values, and the element bit-mask indicates non-zero element values. The processor is configured to randomly access an element value, further comprising: determine a selected block containing the element value from the element coordinate, compute a value table offset from the element coordinate, and access the element value in the value table with the value table offset. The processor is configured to compress the value table by removing all zero element values. The processor is configured to decompress the value table by adding zero element values as indicated by the element bit-mask. The random access can be an operation selected from: push, pop, read, and write and the selected operation is required to perform at least one of: a level set deformation and a volume-rendering. The system includes a cache memory in communication with the processor, wherein blocks are first loaded into the cache memory before being accessed by the processor. The processor is configured to maintain a block bit-mask and a linear block table of pointers to the plurality of blocks, wherein the blocks are sized for cache-efficiency, and compress the linear block table by removing empty blocks. The element bit-mask and the block bit-mask can be used by sequential iterators traversing the volumetric data.

Another embodiment of the present invention can be a computer-readable medium including instructions adapted to execute a method for improved processing of volumetric data. The method includes encoding the volumetric data into a plurality of blocks, wherein each block is associated with: a block topology denoting a relative location of the block within the volumetric data and a set of elements, and each element is associated with: an element topology denoting a relative location of the element within the associated block and a data value. The method includes encoding each block into a value table and an element bit-mask, wherein the value table stores element values, and the element bit-mask indicates non-zero element values. The method includes randomly accessing an element value, further comprising: determining a selected block containing the element value from the element coordinate, computing a value table offset from the element coordinate, and accessing the element value in the value table with the value table offset. The method includes compressing the value table by removing all zero element values. The method includes decompressing the value table by adding zero element values as indicated by the element bit-mask. The random access can be an operation selected from: push, pop, read, and write and the selected operation is required to perform at least one of: a level set deformation and a volume-rendering. The blocks can be sized for cache-efficiency. The method includes maintaining a block bit-mask and a linear block table of pointers to the plurality of blocks, wherein the blocks are sized for cache-efficiency. The method includes compressing the linear block table by removing empty blocks. The element bit-mask and the block bit-mask can be used by sequential iterators traversing the volumetric data.

The specific embodiments described in this document represent examples or embodiments of the present invention, and are illustrative in nature rather than restrictive. In the above description, for purposes of explanation, numerous specific details are set forth in order to provide a thorough understanding of the invention. It will be apparent, however, to one skilled in the art that the invention can be practiced without these specific details.

Reference in the specification to “one embodiment” or “an embodiment” or “some embodiments” means that a particular feature, structure, or characteristic described in connection with the embodiment is included in at least one embodiment of the present invention. Features and aspects of various embodiments may be integrated into other embodiments, and embodiments illustrated in this document may be implemented without all of the features or aspects illustrated or described. It will be appreciated to those skilled in the art that the preceding examples and embodiments are exemplary and not limiting.

While the system, apparatus and method have been described in terms of what are presently considered to be the most practical and effective embodiments, it is to be understood that the disclosure need not be limited to the disclosed embodiments. It is intended that all permutations, enhancements, equivalents, combinations, and improvements thereto that are apparent to those skilled in the art upon a reading of the specification and a study of the drawings are included within the true spirit and scope of the present invention. The scope of the disclosure should thus be accorded the broadest interpretation so as to encompass all such modifications and similar structures. It is therefore intended that the application includes all such modifications, permutations and equivalents that fall within the true spirit and scope of the present invention.

What is claimed is:

1. A method for improved processing of volumetric data, comprising:
encoding the volumetric data into a plurality of blocks, wherein
each block is associated with: a block topology denoting a relative location of the block within the volumetric data and a set of elements, and
each element is associated with: an element topology denoting a relative location of the element within the associated block and a data value;
encoding each block into a value table and an element bit-mask, wherein
the value table stores element values, and
the element bit-mask indicates non-zero element values; and randomly accessing an element value, further comprising:
determining a selected block containing the element value from the element coordinate,
computing a value table offset from the element coordinate, and
accessing the element value in the value table with the value table offset.

2. The method of claim 1, further comprising:
compressing the value table by removing zero element values.

3. The method of claim 3, further comprising:
decompressing the value table by adding zero element values as indicated by the element bit-mask.

4. The method of claim 1, wherein the random access is an operation selected from: push, pop, read, and write.

5. The method of claim 4, wherein the selected operation is required to perform at least one of: a level set deformation and a volume-rendering.

6. The method of claim 1, wherein block pointers are stored in at least one of: a linear block table of pointers and a hash table of pointers.

7. The method of claim 1, further comprising:
maintaining a block bit-mask and a linear block table of pointers to the plurality of blocks, wherein the blocks are sized for cache-efficiency; and
compressing the linear block table by removing empty blocks.

8. The method of claim 7, wherein the element bit-mask and the block bit-mask are used by sequential iterators traversing the volumetric data.

9. A system for improved processing of volumetric data, comprising:
a memory for storing the volumetric data as a plurality of blocks and elements; and
a processor in communications with the memory, the processor configured to
encode the volumetric data into a plurality of blocks, wherein
each block is associated with: a block topology denoting a relative location of the block within the volumetric data and a set of elements, and
each element is associated with: an element topology denoting a relative location of the element within the associated block and a data value,
encode each block into a value table and an element bit-mask, wherein
the value table stores element values, and
the element bit-mask indicates non-zero element values, and
randomly access an element value, further comprising:
determine a selected block containing the element value from the element coordinate,
compute a value table offset from the element coordinate, and
access the element value in the value table with the value table offset.

10. The system of claim 9, the processor further configured to
compress the value table by removing all zero element values, and
decompress the value table by adding zero element values as indicated by the element bit-mask.

11. The system of claim 9, wherein the random access is an operation selected from: push, pop, read, and write and the selected operation is required to perform at least one of: a level set deformation and a volume-rendering.

12. The system of claim 9, further comprising:
a cache memory in communication with the processor, wherein blocks are first loaded into the cache memory before being accessed by the processor.

13. The system of claim 9, the processor further configured to
maintain a block bit-mask and a linear block table of pointers to the plurality of blocks, wherein the blocks are sized for cache-efficiency, and
compress the linear block table by removing empty blocks.

14. The system of claim 9, wherein the element bit-mask and the block bit-mask are used by sequential iterators traversing the volumetric data.

15. A computer-readable storage medium including instructions adapted to execute a method for improved processing of volumetric data, the method comprising:
encoding the volumetric data into a plurality of blocks, wherein
each block is associated with: a block topology denoting a relative location of the block within the volumetric data and a set of elements, and
each element is associated with: an element topology denoting a relative location of the element within the associated block and a data value;
encoding each block into a value table and an element bit-mask, wherein
the value table stores element values, and
the element bit-mask indicates non-zero element values; and
randomly accessing an element value, further comprising:
determining a selected block containing the element value from the element coordinate,
computing a value table offset from the element coordinate, and
accessing the element value in the value table with the value table offset.

16. The medium of claim 15, the method further comprising:
compressing the value table by removing all zero element values; and
decompressing the value table by adding zero element values as indicated by the element bit-mask.

17. The medium of claim 15, wherein the random access is an operation selected from: push, pop, read, and write and the selected operation is required to perform at least one of: a level set deformation and a volume-rendering.

18. The medium of claim 15, wherein the blocks are sized for cache-efficiency.

19. The medium of claim 15, the method further comprising:
maintaining a block bit-mask and a linear block table of pointers to the plurality of blocks, wherein the blocks are sized for cache-efficiency; and
compressing the linear block table by removing empty blocks.

20. The medium of claim 19, wherein the element bit-mask and the block bit-mask are used by sequential iterators traversing the volumetric data.
